(19) United States
(12) Patent Application Publication
(10) Pub. No.: US 2026/0081917 A1
(43) Pub. Date: Mar. 19, 2026

(54) SYSTEMS AND METHODS FOR DIGITAL IDENTIFICATION AND AUTHENTICATION USING COUNTERSIGNATURE VERIFICATION

(71) Applicant: FoxIO, Inc., Austin, TX (US)

(72) Inventors: John Brooke Althouse, Round Hill, VA (US); Michael Damm, Walnut Creek, CA (US)

(21) Appl. No.: 19/328,937

(22) Filed: Sep. 15, 2025

Related U.S. Application Data
(60) Provisional application No. 63/694,833, filed on Sep. 14, 2024.

(51) Int. Cl. H04L 9/40

(52) U.S. Cl. CPC H04L 63/0861; H04L 63/0838; H04L 63/107; H04L 2463/082

(57) ABSTRACT

Systems and methods for digital identification and authentication using countersignature verification are disclosed. The systems and methods enable real-time identity verification between parties by associating a unique digital identification (ID) with a user's identifier, such as an email address. Upon a request for verification, the authenticating user utilizes a countersignature application to perform biometric or multi-factor authentication, triggering the generation of a one-time-use verification code. This code is communicated to a requesting user, who inputs it into the application to confirm the authenticating user's identity via a trusted server. The server validates the code against the digital ID and, upon a successful match, transmits identifying information associated with the digital ID. The systems and methods enhance security and user convenience across various interaction scenarios, including customer support, phishing prevention, and secure business communications.

### CROSS REFERENCE TO RELATED APPLICATION

This application claims the benefit of U.S. Prov. Pat. App. Ser. No. 63/694,833, filed on Sep. 14, 2024. The application cited in this paragraph is incorporated by reference as if set forth fully herein.

### BACKGROUND OF THE DISCLOSURE

### Field

This application is directed generally toward digital identification and authentication systems and methods. More specifically, a system and method for securely verifying the identity of individuals during a communication using a combination of multi-factor authentication and a unique digital ID associated with an email address.

### Description of the Related Art

In the modern AI-capable world, verifying an individual's identity online or over the phone is increasingly important, particularly for preventing fraud, phishing, and other malicious activities. Existing systems, such as security questions, do not scale and are prone to vulnerabilities. There is a need for a more streamlined, secure, and user-friendly method for real-time identity verification between parties.

### SUMMARY OF THE DISCLOSURE

The present disclosure provides a novel system and method for digital identification and authentication using a biometric or other multi-factor-based countersignature verification process. This system acts as a trusted digital identification authority.

Systems and methods according to the present disclosure may be provided to users via a software application for use on a desktop computer, a laptop, or a mobile device. For ease of reference, such an application may be referred to throughout this disclosure as a countersignature application, which can be implemented with a one-time-use identification code, for example.

Exemplary systems and methods according to the disclosure comprise the following components:
Digital ID: Each user is assigned a unique digital ID that is associated with an identifier, such as the user's email address, for example. This digital ID is authenticated using biometric authentication (e.g., fingerprint, facial recognition, and the like) or other multi-factor authentication, depending on user or administrator preference.
Countersignature Verification: When a first user (i.e., a requesting user), for example, an individual wishes to verify the identity of a second user (i.e., an authenticating user), for example, another individual, the requesting user requests the authenticating user to countersign. The authenticating user uses the countersignature application or browser extension to generate a one-time-use code by authenticating with his/her biometrics or other multi-factor authentication device to one or more trusted servers associated with the application which generate the one-time-use code.
Validation Process: the authenticating user communicates the one-time-use code to the requesting user. The requesting user then inputs the code into the countersignature application, which communicates to the trusted server(s) and verifies the identity of the authenticating user by retrieving his/her associated information (name, email address, etc.) from the trusted authority database.
Real-Time Identity Verification: This system allows for real-time identity verification in various scenarios, such as customer support interactions, online transactions, and any situation where confirming the other party's identity is crucial.

These and other further features and advantages of the disclosure would be understood by those skilled in the art from the following detailed description, taken together with any accompanying drawings.

### BRIEF DESCRIPTION OF THE DRAWINGS

FIG. 1 is a flowchart illustrating a method of verifying identification according to an embodiment of the present disclosure.

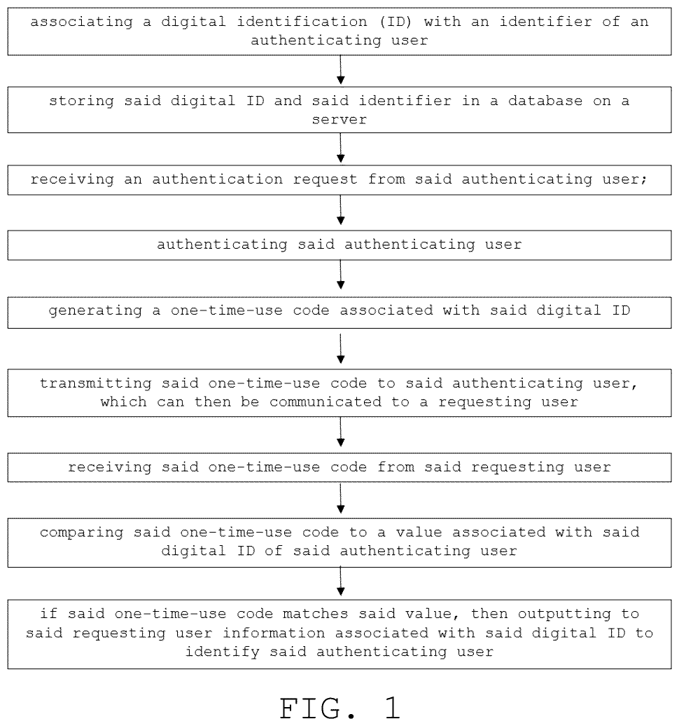

### DESCRIPTION OF THE DISCLOSURE

Embodiments of the disclosure are directed to systems and methods of securely verifying the identity of individuals or agents (i.e., non-human actors) during a communication (e.g., a phone call) using a combination of biometric or other multi-factor authentication techniques and a unique digital ID associated with an identifier, such as an email address, for example.

Throughout this description, preferred embodiments and examples illustrated should be considered as exemplars, rather than as limitations on the present disclosure. As used herein, the term “disclosure,” “device,” “method,” “present disclosure,” “present device,” or “present method” refers to any one of the embodiments of the disclosure described herein, and any equivalents. Furthermore, reference to various feature(s) of the “device,” “method,” “disclosure,” “present disclosure,” “present device,” or “present method” throughout this document does not mean that all claimed embodiments or methods must include the referenced feature(s).

It is also understood that when an element or feature is referred to as being “on” or “adjacent” to another element or feature, it can be directly on or adjacent the other element or feature or intervening elements or features may also be present. It is also understood that when an element is referred to as being “attached,” “connected” or “coupled” to another element, it can be directly attached, connected or coupled to the other element or intervening elements may be present. In contrast, when an element is referred to as being “directly attached,” “directly connected” or “directly coupled” to another element, there are no intervening elements present.

Relative terms such as “outer,” “above,” “lower,” “below,” “horizontal,” “vertical” and similar terms, may be used herein to describe a relationship of one feature to another. It is understood that these terms are intended to encompass different orientations in addition to the orientation depicted in the figures.

Although the terms first, second, etc., may be used herein to describe various elements, components, or steps, these elements, components, or steps should not be limited by these terms. These terms are only used to distinguish one element, component, or step from another element, component, or step. Thus, a first element or component discussed below could be termed a second element or component without departing from the teachings of the present disclosure. As used herein, the term “and/or” includes any and all combinations of one or more of the associated list items.

The terminology used herein is for describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” “including,” “has,” “having,” and similar terms, when used herein, specify the presence of stated features, integers, steps, operations, elements, and/or components, but do not preclude the presence or addition of one or more other features, integers, steps, operations, elements, components, and/or groups thereof.

### System Architecture

The digital ID is created during an initial registration process, where the user provides their email address or any other identifier such a government ID, an account number, an online profile username, or any other personal information that can identify the user, and completes a biometric or other multi-factor authentication procedure. The digital ID and associated information (e.g., name, email, etc.) are stored in a secure, centralized database managed by the trusted authority. The countersignature application or browser extension is available on multiple platforms (e.g., desktop, mobile) and is responsible for generating the one-time-use verification code upon biometric authentication.

### Countersignature Generation

Upon request for identity verification, the authenticating user opens the countersignature application or browser extension. The authenticating user is prompted by the countersignature application to authenticate using their preferred biometric or other multi-factor method. After successful authentication, the countersignature servers generate a one-time-use code (the countersignature) that is displayed to the authenticating user.

### Verification Process

The requesting party receives the one-time-use code from the authenticating user and inputs it into the countersignature application. The authenticating user may transmit the one-time-use code to the requesting user in a real-time communication channel, such as phone call, or a chat session, for example. The countersignature application sends the code to the trusted authority's server, which compares it against a value associated with the authenticating user's digital ID. If the code matches the value, the requesting user receives the relevant information (e.g., name, email) associated with the authenticating user's digital ID, thereby confirming the authenticating user's identity to the requesting user. If the code does not match the value, the requesting user receives a message from the countersignature servers indicating that the authenticating user cannot be verified.

It is also possible to configure the countersignature application to provide only a subset of information associated the digital ID based on a particular purpose. For example, a customer can verify the identity of an employee from Examplco, Inc. calling that customer wherein the only information provided to the customer is an email address with the expected company domain (e.g., john@exampleco.com) so that the customer knows that the person calling is in fact from the company it purports to be. This can be done even though there is more information about John from Exampleco, Inc. associated with his digital ID on the countersignature servers. Thus, a preference can be set for a particular interaction such that only necessary information is divulged to the requesting party during the countersignature process.

### Use Cases

Customer Support. Customers can be quickly and securely identified by support agents without the need for cumbersome identity verification methods, and without the need to exchange sensitive information over a channel which may be compromised (e.g., a phone call, a chat session, etc.).

Phishing Prevention. Customers can verify the legitimacy of calls or emails from companies by requesting a countersignature. If the countersignature does not match the expected domain (e.g., @amazon.com or @irs.gov), the customer can identify potential phishing attempts.

Bank Fraud Prevention. The system can be used to verify the identity of a bank customer if the customer calls the bank or to verify the identity of the bank employee if the bank calls the customer.

Employee Onboarding. A Human Resources representative may request countersignature from a newly hired employee during the onboarding process, and vice versa, to ensure that the communication is in fact between the intended parties.

General Interactions. The system can be used in any scenario where one party needs to verify the identity of another, such as in financial transactions, legal agreements, or even everyday personal interactions. The system is also particularly useful for interactions where the parties would like to avoid the exchange sensitive information over a channel which may be compromised.

### Exemplary Advantages

Security: Biometric authentication ensures that only the authorized individual can generate the one-time-use code (or countersignature), reducing the risk of identity theft or fraud.
Convenience: The system simplifies the identity verification process, eliminating the need for insecure verification methods like multiple security questions, passwords, or lengthy verification procedures.
Versatility: The system can be applied across various industries and use cases, providing a universal solution for identity verification.

The various exemplary inventive embodiments described herein are intended to be merely illustrative of the principles underlying the inventive concept. It is therefore contemplated that various modifications of the disclosed embodiments will without departing from the inventive spirit and scope be apparent to persons of ordinary skill in the art. They are not intended to limit the various exemplary inventive embodiments to any precise form described. Other variations and inventive embodiments are possible in light of the above teachings, and it is not intended that the inventive scope be limited by this specification, but rather by the claims following herein.

Although the present disclosure has been described in detail with reference to certain preferred configurations thereof, other versions are possible. Embodiments of the present disclosure can comprise any combination of compatible features shown in the various figures, and these embodiments should not be limited to those expressly illustrated and discussed. Therefore, the spirit and scope of the disclosure should not be limited to the versions described above. Moreover, it is contemplated that combinations of features, elements, and steps from the appended claims may be combined with one another as if the claims had been written in multiple dependent form and depended from all prior claims. Combination of the various devices, components, and steps described above and in the appended claims are within the scope of this disclosure. The foregoing is intended to cover all modifications and alternative constructions falling within the spirit and scope of the disclosure.

We claim:

1. A method of verifying identification, comprising:
associating a digital identification (ID) with an identifier of an authenticating user;
storing said digital ID and said identifier in a database on a server;
receiving an authentication request from said authenticating user;
authenticating said authenticating user;
generating a one-time-use code associated with said digital ID;
transmitting said one-time-use code to said authenticating user, which can then be communicated to a requesting user;
receiving said one-time-use code from said requesting user;
comparing said one-time-use code to a value associated with said digital ID of said authenticating user;
if said one-time-use code matches said value, then outputting to said requesting user information associated with said digital ID to identify said authenticating user.

2. The method of claim 1, wherein said identifier comprises an email address.

3. The method of claim 1, wherein said authenticating step comprises two-factor authentication.

4. The method of claim 1, wherein said authenticating step comprises biometric authentication.

5. The method of claim 1, further comprising:
if said one-time-use code does not match said value, then outputting to said requesting user a message indicating that said authenticating user cannot be verified.

6. The method of claim 1, wherein said information that is output to said requesting user is a subset of information associated with the digital ID of the authenticating user.

7. The method of claim 1, wherein said one-time-use code is configured to expire after a predetermined time interval.

8. The method of claim 1, wherein said one-time-use code is generated only after confirmation that said authenticating user is geographically located within a predetermined region detected by a location service.

9. The method of claim 1, wherein said authenticating user transmits said one-time-use code to said requesting user through a real-time communication channel selected from a group consisting of a voice call, a text message, or a secure chat session.

10. The method of claim 1, wherein said server is further configured to limit the output of said information associated with said digital ID to only a predetermined subset based on a verification purpose specified by said requesting user.

11. A system for digital identification and authentication, comprising:
a database stored on a trusted server and configured to store a digital identification (ID) associated with an identifier of an authenticating user;
a countersignature application executable on a computing device of said authenticating user and configured to:
prompt said authenticating user to perform an authentication; and
upon successful authentication, request generation of a one-time-use code associated with said digital ID;
a code generation module in communication with said trusted server and responsive to said countersignature application to generate said one-time-use code; and
a verification module configured to receive said one-time-use code from a requesting user, compare said one-time-use code with a value associated with said digital ID, and, when said one-time-use code matches said value, output to said requesting user information associated with said digital ID to verify the identity of said authenticating user.

12. The system of claim 11, wherein said identifier comprises an email address of said authenticating user.

13. The system of claim 11, wherein said countersignature application is further configured to cause said one-time-use code to expire after a predetermined time interval to enhance security.

14. The system of claim 11, wherein said countersignature application is accessible as a browser extension or a mobile application operable on a smartphone, tablet, or desktop computing device.

15. The system of claim 11, wherein said verification module is further configured to limit said information output to said requesting user to a predetermined subset of said information associated with said digital ID based on a verification purpose specified by said requesting user.

16. A non-transitory computer-readable medium storing instructions that, when executed by one or more processors, cause a computing system to perform a method of digital identification and authentication, the method comprising:
associating a digital identification (ID) with an identifier of an authenticating user;
storing said digital ID and said identifier in a database on a trusted server;
receiving an authentication request from said authenticating user via a countersignature application;
authenticating said authenticating user;
generating, in response to said authentication, a one-time-use code associated with said digital ID;
transmitting said one-time-use code to said authenticating user for communication to a requesting user;
receiving said one-time-use code from said requesting user;
comparing said one-time-use code with a value associated with said digital ID of said authenticating user; and
when said one-time-use code matches said value, outputting to said requesting user information associated with said digital ID to verify said identity of said authenticating user.

17. The non-transitory computer-readable medium of claim 16, wherein said identifier comprises an email address of said authenticating user.

18. The non-transitory computer-readable medium of claim 16, wherein said instructions further cause said computing system to generate said one-time-use code such that said code expires after a predetermined time interval.

19. The non-transitory computer-readable medium of claim 16, wherein said instructions further cause said computing system to limit said information output to said requesting user to a subset of said information associated with said digital ID based on a verification purpose.

20. The non-transitory computer-readable medium of claim 16, wherein said instructions further cause said computing system to transmit said one-time-use code to said authenticating user through a real-time communication channel selected from a group consisting of a voice call, a text message, or a secure chat session.
